(19) United States
(12) Patent Application Publication
(10) Pub. No.: US 2022/0247446 A1
(43) Pub. Date: Aug. 4, 2022

(54) METHOD AND APPARATUS TO PRODUCE A WIDEBAND RF SIGNAL

(71) Applicant: Technische Universität Wien, Vienna (AT)

(72) Inventors: Holger Arthaber, Vienna (AT); Daniel Neunteufel, Vienna (AT)

(73) Assignee: Technische Universität Wien, Vienna (AT)

(21) Appl. No.: 17/626,164

(22) PCT Filed: Jul. 21, 2020
(86) PCT No.: PCT/EP2020/070511

§ 371 Date: Jan. 11, 2022

(30) Foreign Application Priority Data
Jul. 25, 2019 (AT) A50672/2019

(51) Int. Cl. H04B 1/40

(52) U.S. Cl. CPC H04B 1/40

(57) ABSTRACT

Method and apparatus to produce a wideband RF signal covering an increased first bandwidth, utilizing at least one narrowband transceiver (1) capable of producing an output RF signal with a base frequency f_{base} and a second bandwidth, wherein the second bandwidth is lower than the first bandwidth, and wherein the base frequency Case depends on the setting of at least one frequency register (2, 2′, 2″), which is adjustable by a control unit, as well as method to estimate the position of a narrowband RF transceiver (1) using a multitude of coherent wideband RF receivers (12) and computer-readable medium comprising computer-executable instructions causing an electronic device to perform the method.

### CROSS REFERENCE TO RELATED APPLICATIONS

The present application is a National Stage Application of PCT International Application No. PCT/EP2020/070511 (filed on Jul. 21, 2020), under 35 U.S.C. § 371, which claims priority to Austrian Patent Application No. A50672/2019 (filed on Jul. 25, 2019), which are each hereby incorporated by reference in their respective entireties.

### TECHNICAL FIELD

The invention relates to a method and an apparatus to produce a wideband RF signal covering an increased first bandwidth, and a method to estimate the position of a narrowband RF transceiver applying this method.

### BACKGROUND

Narrow-band radio-frequency (RF) transceivers are widely applied in System-on-Chip (SoC) applications such as electronic shelve label (ESL) devices, remote controls, or smart sensor applications such as home automation or fitness tracking devices. Such low-power and low-cost transceivers are typically capable of transmitting and receiving only within an RF channel of narrow bandwidth. For example, low-power SoCs such as the Texas Instruments CC2510 series are in principle capable to operate in a frequency range of 2400-2483.5 MHz, but require a specific channel to be selected, having a channel bandwidth of typically just some 100 kHz. This limitation makes such systems incapable to be used for wide-band and ultra-wide-band applications, such as distance measurement or localization based on correlation and triangulation measurement, where RF signals with bandwidths of several 10 MHz are required for precise correlation in order to achieve suitable localization accuracy.

### SUMMARY

One object of the invention is to solve this problem and to provide a method and an apparatus to produce RF signals with increased bandwidth utilizing standard low-power, low-cost transceivers operating with RF signals of a much smaller bandwidth.

This and other objects are solved with a method and an apparatus according to the independent claims.

According to the invention, a method is provided to produce wideband RF signals covering an increased first bandwidth, utilizing at least one narrowband transceiver capable of producing an output RF signal with a base frequency f_{base} and a second bandwidth, wherein the second bandwidth is lower than the first bandwidth, and an output amplifier capable of broadcasting said signal. The base frequency f_{base} is adjustable by a control unit. Such narrowband transceivers are well known and are a common component of low-cost System-on-a-chip devices. In conventional applications, the base frequency f_{base} is only set once, when a certain narrow RF channel for signal transmission and reception is chosen.

According to the invention, the method comprises the following steps: In a first step, the transceiver produces an output signal at a starting base frequency f_{base} within the second bandwidth. The value of f_{base} can be chosen at any frequency within the desired first bandwidth, but preferably it is chosen at or near the upper bound or the lower bound of the first bandwidth.

The output signal can be any signal of the desired RF communication; it might be a signal carrying data with a very narrow bandwidth or even a carrier signal at a fixed frequency and zero bandwidth. The control unit activates the output amplifier to broadcast said signal. Then, while the output amplifier is still active, the control unit sweeps the base frequency f_{base} of the output signal up or down in such a way that the output signal covers the first bandwidth completely or at least partially.

In an embodiment of the method, the base frequency is changed by continuously altering internal settings of the transceiver, such as the values of internal frequency control registers, while the output amplifier is still active.

Instead of said control registers, settings such as the channel number or the channel frequency spacing could be changed as well. Thus, a frequency sweep over an increased first bandwidth can be broadcast. The transceiver will try to follow the demanded frequency setting.

Typically, the transceiver comprises a phase-locked-loop (PLL) which is able to change the frequency of the output signal quickly. By altering the values in the frequency control register, the control unit can increase or decrease the frequency of the output signal, until the output signal has completely covered the desired first bandwidth. By inducing such a fast frequency sweep, the narrowband transceiver is made to cover a bandwidth that is much larger than its own dedicated channel bandwidth.

It might be provided that the control unit deactivates the output amplifier for short intermittent time periods, such at the beginning, at the end, or during the frequency sweep, in particular during each change in the base frequency. During such intermittent time periods, the PLL in the transceiver can stabilize the output signal to create reproducible phase characteristics, without broadcasting the output signal via the output amplifier. Thus, the broadcasting of output signals with phase errors can mostly be avoided.

The base frequency might be consecutively changed by a frequency step Δt wherein after each change the base frequency setting is held constant for a time step Δt. The frequency step Δf might be constant. The time step Δt might be constant as well. The resulting frequency sweep, in some embodiments, might be linear over time.

In alternative embodiments, the frequency step Δf might not be constant, but might increase or decrease while executing the method according to the invention. The time step Δt might also not be constant, but might increase or decrease while executing the method according to the invention. The resulting frequency sweep, in other embodiments, might not be linear over time.

It might further be provided that prior to the method, after the method, or prior, during or after each frequency sweep, in particular while the transceiver changes the base frequency, the output amplifier broadcasts a Continuous Wave Signal at a fixed and predetermined frequency. This allows a receiving entity to better synchronize with the sender and, at the same time, allows the PLL in the transceiver to stabilize the produced signal.

In an embodiment of the invention, the transceiver produces an output signal at an upper base frequency f_{base,high}, and the base frequency f_{base} is repeatedly reduced from the upper base frequency f_{base,high} down to a lower base frequency f_{base,low}. In a further embodiment of the invention, the transceiver produces an output signal at a lower base frequency f_{base,low}, and the base frequency f_{base} is repeatedly increased from the lower base frequency f_{base,low} up to an upper base frequency f_{base,high}. The value of f_{base,high} might be near or at the upper bound of the desired first bandwidth. The value of f_{base,low} might be near or at the lower bound of the desired first bandwidth.

In a further embodiment of the invention, the above method is used to perform a multitude of frequency sweeps through different and overlapping first bandwidths. This results in covering a third bandwidth, which is even larger than each of the overlapping first bandwidths.

There are no inherent limits for the desired bandwidths to be covered, which will in practice depend on the desired application of the method. For example, in order to enable coarse localization, it might be sufficient to cover a bandwidth in the range of 10 MHz to 20 MHz. In other applications, a higher bandwidth in the range of 20 to 200 MHz might be necessary. The bandwidth of the narrow-band transceiver is also not limited. It typically depends on the transceiver chip used and might be less than 2 MHz, for example 0 Hz in the case of a continuous wave transmission, 10 kHz up to 100 kHz or even 500 kHz. These values strongly depend on the application and the transceiver hardware used and are not meant to limit the scope of the invention.

In practice, care has to be taken when choosing the frequency step Δf and the time step Δt, in order to avoid bringing the PLL of the transceiver out of lock.

The time step Δt is preferably chosen long enough and/or a frequency step Δf is chosen small enough to avoid phase errors of the PLL due to unlocking. In some embodiments of the invention, the time step Δt might be in the range of 1 μs to 100 μs. A quicker frequency sweep with shorter time step might yield a lower power consumption, but might have detrimental effects on the stability of the PLL.

In further non-limiting embodiments of the invention, the value of the frequency step Δf might be chosen as an integer multiple of the minimum frequency step size of the transceiver. Example values might be multiples of one to ten; however, the minimum frequency step of the transceiver might be dependent on the reference frequency used and the word length of the frequency control register.

There is also no inherent limitation in the transceiver base frequency f_{base}. In some embodiments, the base frequency might depend on an external reference frequency f_{ref}, which is provided by an external reference oscillator, and the value of the frequency register FREQ according to

$${f}_{b a s e} = \frac{{f}_{r e f}}{frequency divider} \cdot FREQ$$

Depending on the frequency divider, the output frequency is quantized. Consequently, at an external reference frequency of, for example, f_{ref}=26 MHz and a frequency divider setting of 65536, the base frequency of the transceiver 1 can be adjusted in steps of Δf=26 MHz/65536=396 Hz by changing the value of the frequency registers FREQ.

The total output frequency fₒᵤₜ of the transceiver might also depend on a channel register, for example

fₒᵤₜ=f_{base}+f_{channel}=f_{base}+N_{channel}·Δf_{channel}

wherein N_{channel} is the RF channel number and Δf_{channel} channel the channel spacing, which typically ranges from 100 kHz to 1 MHz. Therefore, a minimum value of the frequency step Δf in this specific case would be 100 kHz. In other embodiments of the invention, the frequency step Δf might be below 1000 Hz, in order to enable a smooth sweep over the desired bandwidth.

In further embodiments of the invention, the method according to the invention might be used to estimate the distance between a narrowband RF transceiver according to the invention and external, synchronized and/or coherent wideband RF receivers by transmitting a wideband RF signal from the narrowband RF transceiver. Several methods for distance determination using wideband RF signals are known in the art, and there is no limitation whatsoever to the specific method applied. The method according to the invention can also be used to estimate the location of a narrowband RF transceiver.

For example, the invention might relate to a method to estimate the position of a narrowband RF transceiver using a multitude of synchronized and/or coherent wideband RF receivers. Such methods are known, for example, as triangulation or maximum likelihood. The method comprises, in a first step, broadcasting, by the narrowband transceiver, a wideband RF signal using a method according to the invention. The wideband receivers receive this wideband RF signal at different times, dependent on their distance to the narrowband RF transceiver.

An external computation device can then, from the known position of the wideband RF receivers, determine or estimate the position of the narrowband RF transceiver using methods known from the art. In an exemplary embodiment, the external computation device calculates the cross-correlation of the received wideband RF signals, and from this, the resulting time difference of arrival between the received wideband signals can be determined.

In some embodiments, a set of three synchronized and/or coherent wideband receivers might be used. In further embodiments, the received signal is directly be correlated with the transmitted signal. Other localization methods based on the transmission of wideband RF signals applying a method according to the invention might be used in further embodiments of the invention.

In embodiments of the invention, internal parameters of the transceiver might be determined in a preceding step or during the frequency sweep.

Said parameters might comprise the tolerance of an internal oscillator, locking and/or unlocking behavior of the PLL, settling times of the PLL, temperature and/or supply/battery voltage. These parameters might then be used to choose parameters of the frequency sweep, such as the start time, the time step At and/or the frequency step Δf of the frequency sweep, in order to ensure that the output signal has reproducible and/or known characteristics, such as the change in phase or frequency over time.

In certain applications, the so-determined internal parameters might be transmitted to an external receiver and used for the embodied localization methods. Said parameters might be transmitted to the external receiver by on/off-modulation of a Continuous Wave Signal broadcast by the output amplifier prior, during, or after the frequency sweep. Other embodiments might use a modulation format provided by the SoC.

In further embodiments, at the external receiver, parameters of the frequency sweep, such as frequency deviation from the ideal, start time, and/or start phase, are determined by running statistical analysis, such as a least-squares algorithm, over a single or a multitude of received frequency sweeps.

The invention further relates to a computer-readable medium comprising computer-executable instructions causing an electronic device to perform the method according to the invention. Such electronic device could be, without limitation, the central processing unit of a system-on-a-chip with a narrow-band transceiver executing a method according to the invention.

The invention further relates to an apparatus to produce a wideband RF signal covering an increased first bandwidth, comprising at least one narrowband transceiver capable of producing an output RF signal with a base frequency f_{base} and a second bandwidth, wherein the second bandwidth is lower than the first bandwidth, an output amplifier capable of broadcasting said signal, and a control unit adapted to adjust the base frequency f_{base}. Such apparatus is known in the art.

According to the invention, the transceiver is adapted to produce an output signal at a starting base frequency f_{base} within the second bandwidth.

The control unit is adapted to sweep the base frequency f_{base} up or down in order to have the output signal at least partially cover the first bandwidth, wherein the control unit is further adapted to activate the output amplifier to broadcast the output signal during the whole or during at least parts of this frequency sweep.

In some embodiments of the invention, such apparatus is part of, or built as a system-on-a-chip, such as an electronic shelve label, smart sensor, or fitness tracker.

Further features of the invention are apparent from the claims, the description of embodiments and the attached figures.

### DRAWINGS

FIG. 1 shows a schematic overview of an embodiment of a system-on-a-chip comprising an embodiment of an apparatus according to the invention;

FIGS. 2a through 2d show schematic diagrams of the output signal magnitude over frequency during execution of an embodiment of a method according to the invention;

FIGS. 3a and 3b show schematic Bode plots of the output signal during execution of an embodiment of a method according to the invention;

FIG. 3c shows a schematic plot of the frequency and phase error of the output signal over time during execution of an embodiment of a method according to the invention;

FIG. 4 shows a schematic overview of a system for localization executing an embodiment of a method according to the invention.

### DESCRIPTION

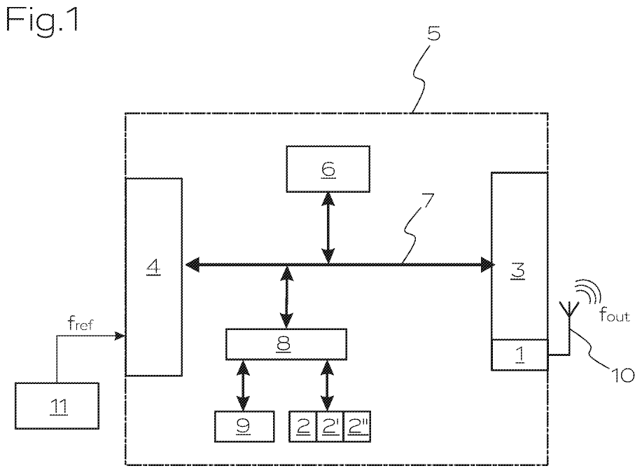

FIG. 1 depicts a schematic block diagram of a system-on-a-chip 5 in which an embodiment of an apparatus according to the invention is implemented, for example as an electronic shelve label (ESL), a remote control, or a smart sensor application such as home automation or fitness tracking devices. Such device can be configured to perform embodiments of the methods as described herein.

The system-on-a-chip 5 includes, as a control unit, a central processing unit (CPU) 6, such as a microcontroller, ARM microprocessor, or application-specific instruction set processor or the like. The central processing unit 6 is connected to a local system bus 7, such as an ARM Advanced Microcontroller Bus Architecture (AMBA), peripheral component interconnect (PCI) architecture bus or the like.

Connected to local system bus 7 in the depicted embodiment are a memory controller 8 which interfaces a main memory 9 and frequency registers 2, 2′, 2″, a RF module 3 with transceiver 1, and an input/output (I/O) interface 4. The main memory 9 might be any machine-readable electronic storage medium, including but not limited to nonvolatile, mediums such as read only memories (ROMs) or erasable, electrically programmable read only memories (EEPROMs), Flash memory, SRAM, and the like. The I/O interface 4 may be based on industry standards such as USB, FireWire, Ethernet, USART, I²S, and the like, and will differ according to the intended application. Wireless networking protocols such as Wi-Fi or Bluetooth may also be supported. Further, an external oscillator 11 is connected to the I/O interface 4 and provides a reference frequency f_{ref} for the RF module 3.

The transceiver 1 is part of an RF module 3 and comprises an RF receiver and an RF transmitter, transmitting and receiving through an attached antenna 10. Carrier frequencies used in the RF module 3 might include those in the industrial, scientific and medical (ISM) radio bands such as 433.92 MHz, 915 MHz, 2.45 GHz, and 5.8 GHz wherein channels of narrow bandwidths in the range of 10 kHz to 100 kHz might be provided.

The RF module 3 may comply with a defined protocol for RF communications such as Zigbee, Bluetooth low energy, or Wi-Fi, or it may implement a proprietary protocol. It might operate in full-duplex or half-duplex mode, and might apply different narrow-band RF signal modulation schemes such as, for example, 2-FSK, GFSK and/or MSK.

Frequency registers 2, 2′, 2″ might be provided and might be interfaced by the memory controller 8, or might be interfaced separately. In this particular embodiment, the frequency registers comprise a first register 2 (denoted as FREQ0), a second register 2′ (denoted as FREQ1), and a third register 2″ (denoted as FREQ2) of 8-bit each, which together form a 24-bit carrier frequency register. Setting of the frequency registers 2, 2′, 2″ determines the base frequency f_{base} of the transceiver operation.

Those of ordinary skill in the art will appreciate that the hardware depicted in FIG. 1 may vary for particular implementations.

Further possible components, such as power supply, voltage regulator, memory controller, I/O controller, Timer, internal reference oscillator, and the like will be apparent to the skilled person and are therefore not described. The depicted example is provided for the purpose of explanation only and is not meant to imply architectural limitations with respect to the present disclosure.

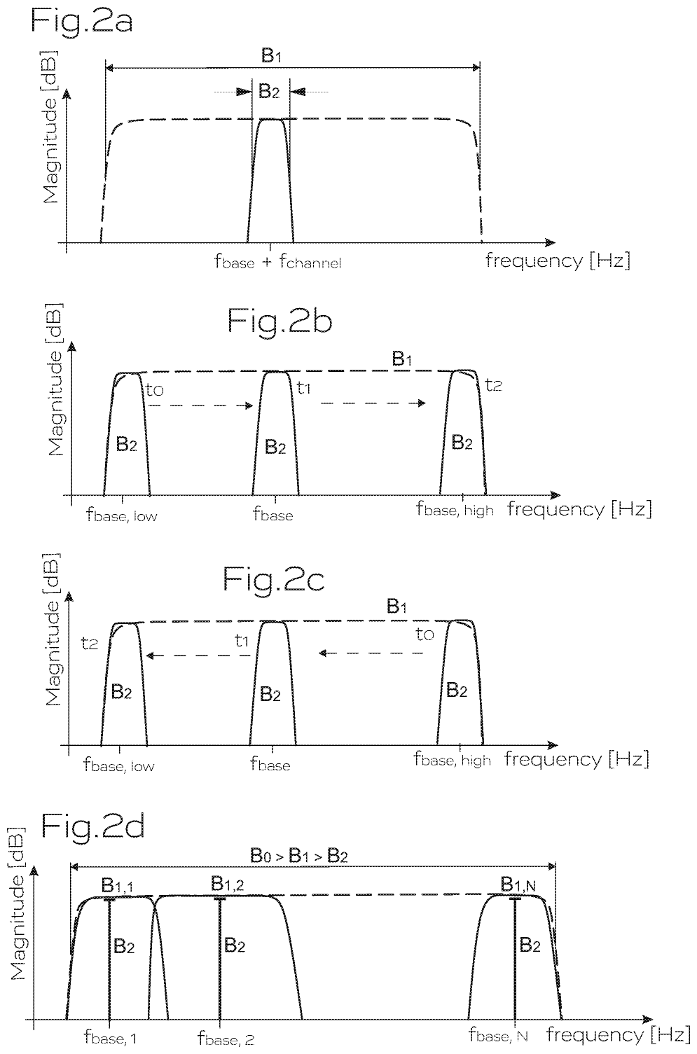

FIG. 2a shows a schematic plot of magnitude over frequency of the desired wideband RF signal covering an increased first bandwidth B1, and shows the actual output signal of the transceiver 1 with narrow second bandwidth B2. It can be seen that the output signal of the transceiver 1 is located around f_{base}+f_{channel} within a narrow second bandwidth B₂ smaller than the desired first bandwidth B₁. In embodiments not shown, the output signal is a single-frequency carrier with zero bandwidth. The output signal of the transceiver 1 therefore cannot reach the desired first bandwidth B₁.

FIG. 2b shows the same plot at different time steps while an embodiment of a method according to the invention is carried out. While the channel frequency f_{channel} is kept constant, the base frequency f_{base} swept from a low value f_{base,low} to a high value f_{base,high} in consecutive time steps t₀<t₁<t₂.

The value of f_{channel} has been kept constant and is disregarded in this plot. Thus, by constantly increasing the base frequency of the transceiver 1 in consecutive time steps, a much higher bandwidth of the output signal can be reached.

FIG. 2c shows the same plot in different time steps while a further embodiment of the method according to the invention is carried out. While the channel frequency f_{channel} is kept constant, in this embodiment the base frequency f_{base} is swept from a high value f_{base,high} to a low value f_{base,low} in consecutive time steps t₀<t₁<t₂. The value of f_{channel} is disregarded in this plot. Thus, by constantly reducing the base frequency of the transceiver 1, a much higher bandwidth of the output signal can be reached.

In further embodiments not shown, the base frequency f_{base} is swept over the increased bandwidth B₁ in non-consecutive and preferably random time steps.

FIG. 2d shows a schematic plot of magnitude over frequency at different time steps while a further embodiment of the method according to the invention is carried out. In this embodiment, a multitude N of frequency sweeps are performed through different and overlapping first bandwidths B_{1,i}=B_{1,1}, B_{1,2}, . . . , B_{1,N}. In this embodiment, the output signal is a single-frequency carrier with different base frequencies f_{base,1}, f_{base,2}, . . . , f_{base,N} with zero bandwidth, denoted in the figure as B₂=0 Hz which is swept over each partial bandwidth B_{1,i} in order to cover a third bandwidth B₀ which is even larger than each of the overlapping first bandwidths B_{1,i}.

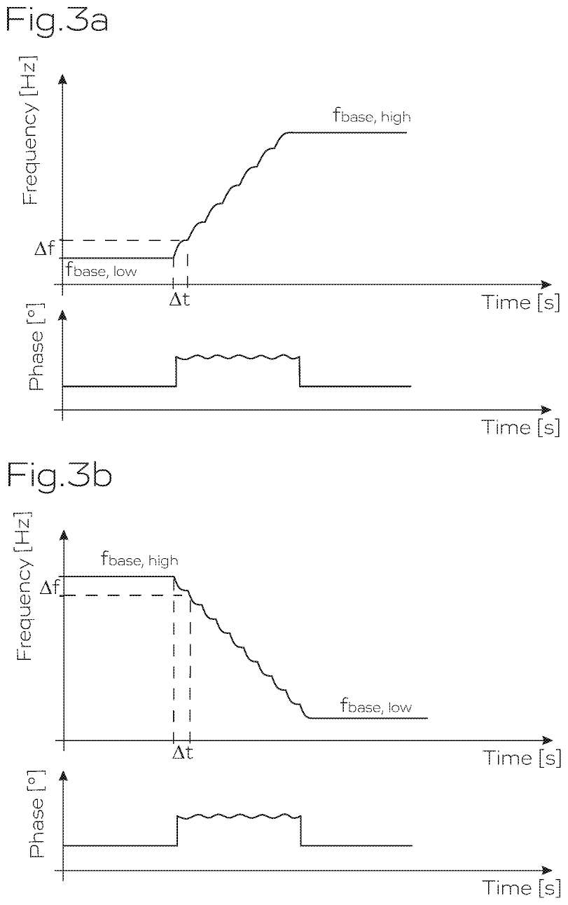

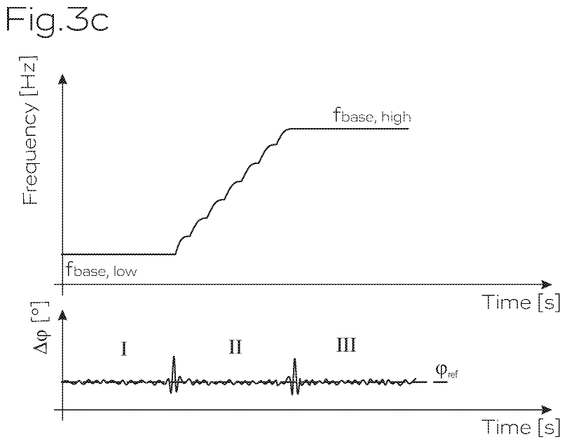

FIGS. 3a and 3b show schematic Bode plots of the transceiver's output signal, referenced to an ideal sweep signal, during execution of an embodiment of a method according to the invention.

According to the embodiment in FIG. 3a, the base frequency of the transceiver f_{base} is swept from a low value f_{base,low} to a high value f_{base,high} in consecutive time steps Δt. The value of f_{channel} has been kept constant and is disregarded in this plot. Thus, by constantly increasing the base frequency of the transceiver 1 in consecutive time steps, a much higher bandwidth of the output signal is reached. It is shown that the frequency sweep does not follow an ideal straight line, as the PLL of the transceiver will have to accommodate to the desired frequency changes. This leads, in this embodiment, to a small non-linearity in the frequency of the output signal. As seen in the phase plot, however, the time steps Δt and the frequency steps Δf are chosen in such a way that there might be a slight offset, but no significant phase variation during the sweep in the output signal.

According to the embodiment in FIG. 3b, the base frequency of the transceiver f_{base} is swept from a high value f_{base,high} to a low value f_{base,low} in consecutive time steps Δt. The value of f_{channel} has been kept constant and is disregarded in this plot. Thus, by constantly decreasing the base frequency of the transceiver 1 in consecutive time steps, a much higher bandwidth of the output signal is reached. It is shown that the frequency sweep does not follow an ideal straight line, as the PLL of the transceiver will have to accommodate to the desired frequency changes.

This leads, in this embodiment, to a small non-linearity in the frequency of the output signal. As seen in the phase plot, however, the time steps Δt and the frequency steps Δf are chosen in such a way that there is no significant phase variation during the sweep in the output signal.

FIG. 3c shows a schematic plot of the frequency and phase error Δφ of the output signal over time between the transmitted signals of multiple executions of an embodiment of a method according to the invention. It can be seen that the phase error is more or less negligible during the frequency sweep from f_{base,low} to f_{base,high}, but increases at the beginning and end of the frequency sweep. In some embodiments of the invention, frequency sweeps are repeated in order to allow receiving devices to deduce sweep parameters from the received signal and/or to improve localization performance, for example, by averaging received signal waveforms over multiple sweeps.

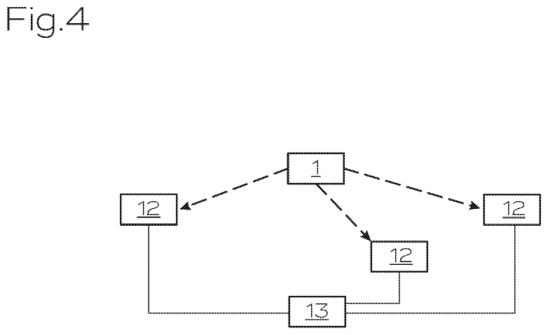

FIG. 4 shows a schematic overview of a system for localization of a narrowband transceiver 1, executing an embodiment of a method according to the invention. A narrowband transceiver 1 is located at an unknown position. Three coherent wideband receivers 12 are located at known positions and connected to a computation device 13. The transceiver 1 employs a method according to the invention to broadcast a wideband RF signal. The wideband receivers 12 receive the signal, which, due to the different distance to the transceiver 1, will be phase-shifted. The external computation device 13 calculates a cross-correlation of the received wideband RF signals and extracts, from the phase difference, the resulting time difference of arrival between the received wideband signals. From the difference in time of arrival and the known position of the receivers, the external computation device 13 determines the position of the narrowband RF transceiver 1.

Further applications of the method according to the invention fall into the scope of the attached claims and will be apparent to the skilled person, thus they need not be described in detail.

### LIST OF REFERENCE NUMERALS

1 Transceiver
2, 2′, 2″ Frequency register
3 RF module
4 I/O interface
5 System-on-chip
6 Central processing unit
7 Local system bus
8 Memory controller
9 Main memory
10 Antenna
11 External oscillator
12 Receivers
13 Computation device

1-16. (canceled)

17. A computer-implemented method to produce a wideband RF signal covering an increased first bandwidth, utilizing at least one narrowband transceiver capable of producing an output RF signal with a base frequency and a second bandwidth that is lower than the first bandwidth, and an output amplifier capable of broadcasting said signal, wherein the base frequency is adjustable by a control unit, the method comprising:
producing, by the at least one transceiver, an output signal at a starting base frequency within the second bandwidth;
activating, by the control unit, the output amplifier to broadcast the output signal; and
sweeping, by the control unit, the base frequency up or down while the output amplifier is active, in order to have the output signal at least partially cover the first bandwidth.

18. The computer-implemented method of claim 17, wherein the base frequency is changed by altering internal setting of the at least one narrowband transceiver, such as the values of frequency control registers to have the at least one narrowband transceiver increase or decrease the base frequency.

19. The computer-implemented method of claim 17, wherein:
the base frequency is consecutively changed by a frequency step, and
after each change, the base frequency setting is held constant for a time step.

20. The computer-implemented method of claim 17, wherein prior, during, or after each frequency sweep, the output amplifier broadcasts a continuous wave signal at a fixed and predetermined frequency.

21. The computer-implemented method of claim 17, wherein:
the at least one narrowband transceiver produces an output signal at an upper base frequency, and the base frequency is repeatedly reduced from the upper base frequency down to a lower base frequency, or
the at least one narrowband transceiver produces an output signal at a lower base frequency, and the base frequency is repeatedly increased from the lower base frequency up to an upper base frequency.

22. The computer-implemented method of claim 21, wherein the value of the frequency step is an integer multiple of the minimum frequency step size of the at least one narrowband transceiver.

23. The computer-implemented method of claim 17, wherein a multitude of frequency sweeps are performed through different overlapping first bandwidths, resulting in covering a third bandwidth larger than each of the overlapping first bandwidths.

24. A computer-implemented method to estimate a position of a narrowband RF transceiver using a plurality of synchronized and/or coherent wideband RF receivers, the method comprising:
broadcasting, by the narrowband transceiver, a wideband RF signal covering an increased first bandwidth utilizing the at least one narrowband transceiver capable of producing an output RF signal with a base frequency and a second bandwidth that is lower than the first bandwidth, and an output amplifier capable of broadcasting said signal, wherein the base frequency is adjustable by a control unit, by producing, by the narrowband RF transceiver, an output signal at a starting base frequency within the second bandwidth, activating, by the control unit, the output amplifier to broadcast the output signal, and sweeping, by the control unit, the base frequency up or down while the output amplifier is active, in order to have the output signal at least partially cover the first bandwidth;
receiving, by the wideband RF receivers, the wideband RF signal; and
determining, by an external computation device, from the position of the wideband RF receivers, the position of the narrowband RF transceiver.

25. The computer-implemented method of claim 24, wherein during the frequency sweep, internal parameters of the narrowband RF transceiver are determined, such as the tolerance of an internal oscillator or the phase offset, the time offset and/or the frequency offset of the output amplifier.

26. The computer-implemented method of claim 25, wherein the following parameters are used to choose parameters of the frequency sweep, in order to ensure that the output signal has reproducible characteristics, such as a change in phase or frequency over time:
a start time,
a time step, and/or
a frequency step of the frequency sweep.

27. The computer-implemented method of claim 26, wherein the parameters are transmitted to an external receiver and used for the correlation of sent and received signals.

28. The computer-implemented method of claim 27, wherein the parameters are transmitted to the external receiver by on/off-modulation of a continuous wave signal broadcast by the output amplifier prior, during, or after the frequency sweep.

29. The computer-implemented method of claim 28, wherein at the external receiver, parameters of the frequency sweep, such as frequency deviation from the ideal, start time, start phase and/or frequency step, are determined by running statistical analysis, such as a least-squares algorithm, over a single or a multitude of received frequency sweeps.

30. A computer-readable medium, comprising computer-executable instructions, which when executed by an electronic device, cause the electronic device to produce a wideband RF signal covering an increased first bandwidth by:
producing, by at least one narrowband transceiver capable of producing an output RF signal with an adjustable base frequency and a second bandwidth that is lower than the first bandwidth, and an output amplifier capable of broadcasting said signal, an output signal at a starting base frequency within the second bandwidth;
activating the output amplifier to broadcast the output signal; and
sweeping the base frequency up or down while the output amplifier is active, in order to have the output signal at least partially cover the first bandwidth.

31. The computer-readable medium of claim 30, wherein the electronic device comprises an electronic shelve label.

32. The computer-readable medium of claim 30, wherein the electronic device comprises a smart sensor.

33. The computer-readable medium of claim 30, wherein the electronic device comprises a fitness tracker.
